(19) United States
(12) Patent Application Publication
(10) Pub. No.: US 2012/0063696 A1
(43) Pub. Date: Mar. 15, 2012

(54) IMAGE ENCODING METHOD AND SERVER IMPLEMENTING THE METHOD

(75) Inventors: CHUNG-I LEE, Tu-Cheng (TW); CHIEN-FA YEH, Tu-Cheng (TW); CHIU-HUA LU, Tu-Cheng (TW); CHENG-FENG TSAI, Tu-Cheng (TW); SHAN-CHUAN JENG, Tu-Cheng (TW); TSUNG-HSIN YEN, Tu-Cheng (TW); YU-FENG CHIEN, Tu-Cheng (TW)

(73) Assignee: HON HAI PRECISION INDUSTRY CO., LTD., Tu-Cheng (TW)

(21) Appl. No.: 12/953,403

(22) Filed: Nov. 23, 2010

(30) Foreign Application Priority Data
Sep. 15, 2010 (TW) 99131130

(51) Int. Cl. G06K 9/36; H04N 7/26

(52) U.S. Cl. 382/239; 375/240.02; 375/E07.126

(57) ABSTRACT

A method for encoding images receives a specified type of an image request from a terminal device, obtains encoded images from a storage device of the server directly upon the condition that the image request has been processed. The method further adds a task into a coder of the server to process the image request upon the condition that the image request has not been processed, encodes captured images by the coder according to the image request, stores the encoded images and the corresponding specified type of the image request in the storage device, and outputs the encoded images to the terminal device.

### BACKGROUND

1. Technical Field

Embodiments of the present disclosure relate to data encoding technology, and particularly to a method for encoding images and a corresponding server implementing the method.

2. Description of Related Art

Monitors have been used to perform security surveillance by capturing images of a number of monitored scenes, and sending the captured images to a monitor server. The monitor server encodes the captured images, and stores the encoded images into a storage devices of the monitor server. An administrator can obtain the encoded images of the monitored scenes from the storage device of the monitor server using a terminal device (e.g., a mobile phone) through a network.

However, because a size of a display screen of each kind of terminal devices is different, if the encoded image is bigger than the size of the display screen of the terminal device, some portions of the encoded images cannot be shown on the display screen of the terminal device. Therefore, an efficient method for encoding images is desired.

### BRIEF DESCRIPTION OF THE DRAWINGS

FIG. 1 is a schematic diagram of one embodiment of a server communicating with a number of terminal devices.

FIG. 2 is a block diagram of one embodiment of the server.

FIG. 3 is a flowchart of one embodiment of a method for encoding images according to a size of a display screen of each of the terminal devices.

FIG. 4 is an example of encoding images according to different images requests using the method in FIG. 3.

### DETAILED DESCRIPTION

All of the processes described below may be embodied in, and fully automated via, functional code modules executed by one or more general purpose electronic devices or processors. The code modules may be stored in any type of non-transitory readable medium or other storage device. Some or all of the methods may alternatively be embodied in specialized hardware. Depending on the embodiment, the non-transitory readable medium may be a hard disk drive, a compact disc, a digital video disc, a tape drive or other suitable storage medium.

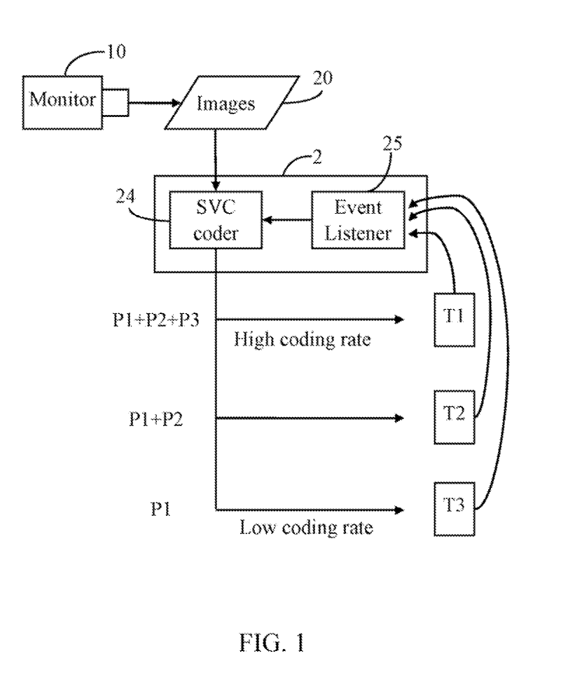

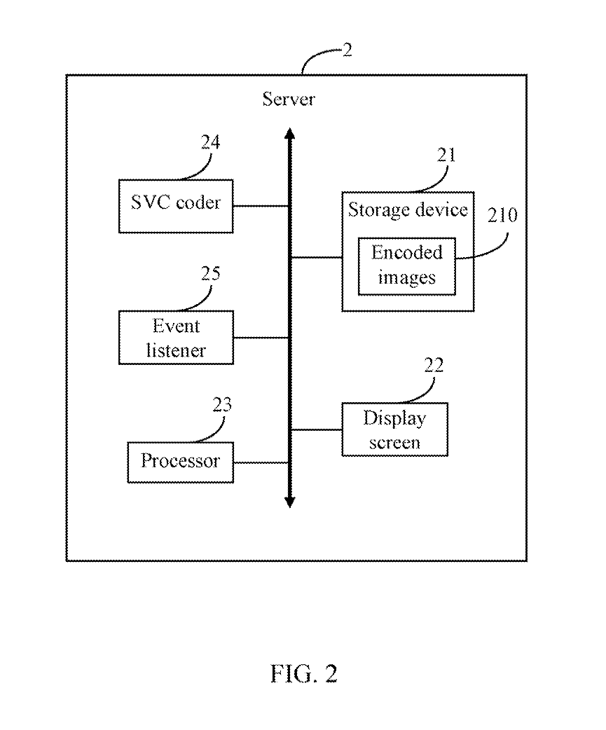

FIG. 1 is a schematic diagram of one embodiment of a server 2 communicating with a number of terminal devices T1, T2, and T3. In one embodiment, referring to FIG. 2, the server 2 includes a storage device 21, a display screen 22, at least one processor 23, a scalable video coding (SVC) coder 24 and an event listener 25. The SVC coder 24 may be used to receive captured images 20 sent from a monitor 10. The event listener 25 may be used to detect image requests sent from the terminal devices T1, T2, and T3, and send the image requests to the SVC coder 24. In one embodiment, the monitor 10 may be speed dome cameras or pan/tilt/zoom (PTZ) cameras, or Internet Protocol (IP) cameras, for example.

In one embodiment, the SVC coder 24 may be used to encode the captured images 20 according to the size of the display screen of each of the terminal devices T1, T2, and T3 to obtain encoded images 210 having different sizes, store the encoded images 210 in the storage device 21, and send back the encoded images 210 to the terminal devices T1, T2, and T3. A detailed description will be given in the following paragraphs.

As shown in FIG. 1, “P1” represents a first coding region (e.g., 800*600 resolution) of the captured image, “P2” represents a second coding region (e.g., 1024*768 resolution) of the captured image, “P3” represents a third coding region (e.g., 1280*1024 resolution) of the captured image. In one embodiment, P1<P2<P3. It should be understood that the dimensions of the first, second, and third coding regions are exemplary and may depend on the embodiment. The terminal device “T1” includes three coding regions (i.e., P1, P2, and P3), the terminal device “T2” includes two coding regions (i.e., P1 and P2), and the terminal device “T3” includes one coding region (i.e., P1). If the size (e.g., resolution) of the display screen of the terminal device “T1” is bigger than the size (e.g., resolution) of the display screen of the terminal device “T2”, the size of the coding region of the terminal device “T1” is bigger than the size of the coding region of the terminal device “T2.”

In one embodiment, the display screen 22 may be a liquid crystal display (LCD) or a touch-sensitive display, for example. The terminal device T1, T2, and T3 may be mobile phones, a personal digital assistants (PDAs), or any other suitable communication devices.

In one embodiment, the server 2 may include one or more modules. The one or more modules may comprise computerized code in the form of one or more programs that are stored in the storage device 21 (or memory). The computerized code includes instructions that are executed by the at least one processor 23 to provide functions for the one or more modules.

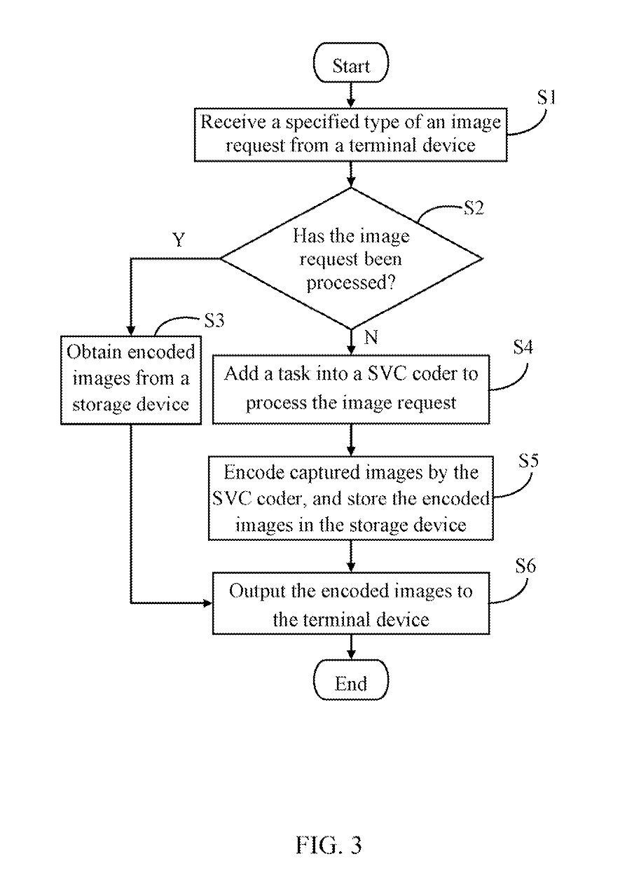

FIG. 3 is a flowchart of one embodiment of a method for encoding images according to a size of a display screen of each of the terminal devices. Depending on the embodiment, additional blocks may be added, others removed, and the ordering of the blocks may be changed.

In block S1, the event listener 25 of the server 2 receives a specified type of an image request from a terminal device (e.g., the terminal device “T3”). In one embodiment, the specified type of the image request includes a size of the coding region of the captured image 20, a position of the coding region in the current image 20, and a corresponding coding rate of the coding region.

In block S2, the server 2 determines if the specified type of the image request has been processed by the SVC coder 24. In one embodiment, if the SVC coder 24 has encoded the captured images 20 of the specified type of the image request, the server 2 determines that the specified type of the image request has been processed by the SVC coder 24. If the specified type of the image request has been processed by the SVC coder 24, the procedure goes to block S3. If the specified type of the image request has not been processed by the SVC coder 24, the procedure goes to block S4. A detailed example is provided below to explain how to determine an image request.

In block S3, the server 2 obtains encoded images 210 from the storage device 21 of the server 2 according to the specified type of the image request, then the procedure goes to block S6.

In block S4, the server 2 adds a task into the SVC coder 24 to process the image request.

In block S5, the SVC coder 24 encodes the captured images 20 according to the image request, and stores the encoded images 210 and the corresponding specified type of the image request in the storage device 21.

In block S6, the server 2 outputs the encoded images 210 to the terminal device.

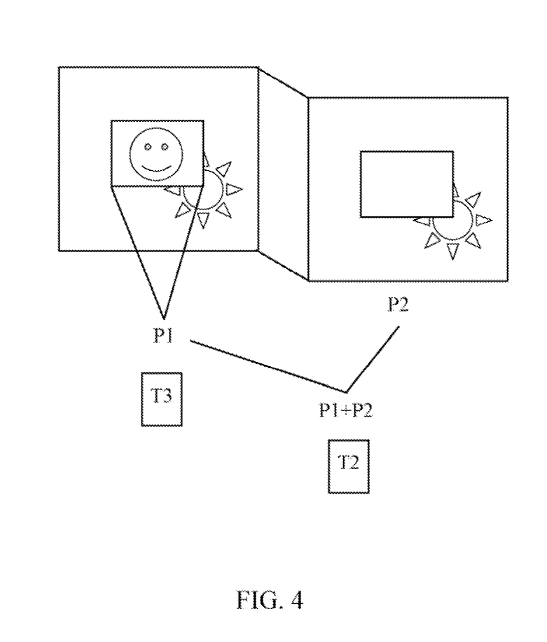

Referring to FIG. 4, supposing that the terminal device “T3” sends a first image request with the first coding region “P1” to the server 2. If the first coding region “P1” has not been processed by the SVC coder 24 before, the server 2 encodes the captured images 20 according to the first coding region “P1” using the SVC coder 24, and stores the coded images and the specified type of the first image request in the storage device 21.

If the terminal device “T2” sends the first image request with the first coding region “P1” and a second image request with the second coding region “P2” to the server 2. Because the first coding region “P1” has been processed by the SVC coder 24, the server 2 just processes the second image request with the second coding region “P2” using the SVC coder 24, and the encoded images 210 corresponding to the first image request can be obtained from the storage devices 21 directly.

In other embodiments, the SVC coder 24 may be replaced with other suitable coders according to different coding requests.

It should be emphasized that the above-described embodiments of the present disclosure, particularly, any embodiments, are merely possible examples of implementations, merely set forth for a clear understanding of the principles of the disclosure. Many variations and modifications may be made to the above-described embodiment(s) of the disclosure without departing substantially from the spirit and principles of the disclosure. All such modifications and variations are intended to be included herein within the scope of this disclosure and the present disclosure and protected by the following claims.

What is claimed is:

1. A method for encoding images using a server, comprising:
receiving a specified type of an image request from a terminal device;
obtaining encoded images from a storage device of the server according to the specified type of the image request upon the condition that the specified type of the image request has been processed by a coder of the server, and outputting the encoded images to the terminal device; or
adding a task into the coder of the server to process the image request upon the condition that the specified type of the image request has not been processed by the coder of the server, encoding captured images by the coder according to the image request, storing the encoded images and the corresponding specified type of the image request in the storage device, and outputting the encoded images to the terminal device.

2. The method according to claim 1, wherein the specified type of the image request comprises a size of a coding region of the captured image, a position of the coding region in the captured image, and a corresponding coding rate of the coding region.

3. The method according to claim 1, wherein the coder is a scalable video coding (SVC) coder.

4. The method according to claim 1, wherein the captured images are obtained from a monitor connected with the server.

5. The method according to claim 4, wherein the monitor is a speed dome camera or a pan/tilt/zoom (PTZ) camera.

6. A server, comprising:
a display screen;
a storage device;
at least one processor; and
one or more modules that are stored in the storage device and are executed by the at least one processor, the one or more modules comprising instructions:
to receive a specified type of an image request from a terminal device;
to obtain encoded images from a storage device of the server according to the specified type of the image request upon the condition that the specified type of the image request has been processed by a coder of the server, and output the encoded images to the terminal device; or
to add a task into the coder of the server to process the image request upon the condition that the specified type of the image request has not been processed by the coder of the server, encode captured images by the coder according to the image request, store the encoded images and the corresponding specified type of the image request in the storage device, and output the encoded images to the terminal device.

7. The server according to claim 6, wherein the specified type of the image request comprises a size of a coding region of the captured image, a position of the coding region in the captured image, and a corresponding coding rate of the coding region.

8. The server according to claim 6, wherein the coder is a scalable video coding (SVC) coder.

9. The server according to claim 6, wherein the captured images are obtained from a monitor connected with the server.

10. The server according to claim 9, wherein the monitor is a speed dome camera or a pan/tilt/zoom (PTZ) camera.

11. A non-transitory storage medium having stored thereon instructions that, when executed by a processor of an electronic device, causes the processor to perform a method for encoding images, the method comprising:
receiving a specified type of an image request from a terminal device;
obtaining encoded images from a storage device of a server according to the specified type of the image request upon the condition that the specified type of the image request has been processed by a coder of the server, and outputting the encoded images to the terminal device; or
adding a task into a coder of the server to process the image request upon the condition that the specified type of the image request has not been processed by the coder of the server, encoding captured images by the coder according to the image request, storing the encoded images and the corresponding specified type of the image request in the storage device, and outputting the encoded images to the terminal device.

12. The non-transitory storage medium according to claim 11, wherein the specified type of the image request comprises a size of a coding region of the captured image, a position of the coding region in the captured image, and a corresponding coding rate of the coding region.

13. The non-transitory storage medium according to claim 11, wherein the coder is a scalable video coding (SVC) coder.

14. The non-transitory storage medium according to claim 11, wherein the captured images are obtained from a monitor connected with the server.

15. The non-transitory storage medium according to claim 14, wherein the monitor is a speed dome camera or a pan/tilt/zoom (PTZ) camera.

16. The non-transitory storage medium according to claim 11, wherein the medium is selected from the group consisting of a hard disk drive, a compact disc, a digital video disc, and a tape drive.
